(19) United States
(12) Patent Application Publication
(10) Pub. No.: US 2013/0173362 A1
(43) Pub. Date: Jul. 4, 2013

(54) METHODS AND SYSTEMS FOR DISPLAYING AND ADVERTISING PRODUCTS AND SERVICES USING INTERACTIVE MIXED MEDIA

(71) Applicants: Tiger T G Zhou, Tiburon, CA (US); Dylan T X Zhou, San Gabriel, CA (US); Andrew H B Zhou, Tiburon, CA (US)

(72) Inventors: Tiger T G Zhou, Tiburon, CA (US); Dylan T X Zhou, San Gabriel, CA (US); Andrew H B Zhou, Tiburon, CA (US)

(21) Appl. No.: 13/343,044

(22) Filed: Jan. 4, 2012

(51) Int. Cl. G06Q 30/02

(52) U.S. Cl. 705/14.4

(57) ABSTRACT

Provided are methods and systems for advertising using interactive mixed media, which are based on providing multiple advertising content components in the same user interface and allowing users to switch between the different advertising content components using a content selection tool provided by the interface. Specifically, different content formats may be simultaneously combined in the same user interface, and then modified by the user to constitute the most optimal collection of the advertisement content components. A user may toggle between the different advertisements content components to gather additional information. For example, the initially presented content may provide some general product information. The user may then choose to explore some specific features of the product by selecting some specific part of the content. Furthermore, the user may select content that is more suitable to this particular user.

### FIELD

This application relates generally to internet advertising and, more specifically, to computer-implemented methods and systems for advertising using interactive mixed media.

### BACKGROUND

Online shopping or online retailing is becoming more and more popular because of the typically lower prices and absence of the sales pressure that is commonly present in traditional brick-and-mortar retail establishments. Online shopping is a process whereby consumers can buy goods or services from a seller in real time over the Internet. Online shopping is a form of electronic commerce. Buying from an online shop (also known as e-shop, e-store, internet shop, webshop, webstore, online store, or virtual store) is akin to buying products or services at a bricks-and-mortar retailer, or in a shopping center. This process is often referred to as Business-to-Consumer online commerce and involves purchasing products by consumers. Similarly, Business-to-Business online commerce involves purchasing products by another other businesses.

During online shopping, consumers locate products or services by visiting various retailer websites directly, or by making a search across many different vendors using some form of a search engine, e.g., a comparison shopping search engine. With most online retailers, once a specific product has been found on the seller's web site, the consumer can use shopping cart software to accumulate multiple items and adjust their quantities, in a way similar to how a physical shopping cart or basket is filled in a conventional store. The procedure is followed by the checkout process in which, if necessary, the payment and delivery information is collected.

A major part of online shopping is collecting information about the offered products or services. However, unlike a traditional brick-and-mortar establishment where this kind of information is typically provided by a sales assistant who can easily adapt to the consumers' varying needs, online retailers generally just provide products. Typically, online retailers generally do not know who has browsed their products until these products are actually paid for. However, different types of online consumers may need different types of product information depending on their demographics, such as geographical presence/language, age, gender, education level, interest, etc. For example, some user may prefer to watch an exciting marketing video of the product, while others may prefer to read a detailed technical specification of the product. Online retailers may provide a large amount of product information on their websites. This information is generally arranged under different tabs or on different webpages altogether, thereby making obtaining the information difficult. There are presently no solutions to provide a specific type of consumer product information that has different content and/or is arranged in different formats on the same screen. Furthermore, searching for information may take the user away from the website of the online retailer to the website of another retailer, thus making it difficult to retain customers and ensure the successful conversion of the transaction.

### SUMMARY

Provided are methods and systems for advertising using interactive mixed media, which may include multiple advertising content components within the same user interface, whereby users are allowed to switch between different advertising content components using a content selection tool. Specifically, different content formats may be simultaneously combined within the same user interface and then modified by the user to constitute an optimal collection of the advertising content components. The user may toggle between different advertising content components to gather additional information. For example, the initially presented content may provide some general product information. The user may then choose to explore some specific features of the product by selecting particular content. Furthermore, the user may select content that is more suitable to this user, such as, for example, content presented in a specific language or meeting some of the user's specific interests. The methods and systems may be applied with respect to computer screens, touch screen devices, mobile devices, TV, outdoor and indoor big screen devices.

In certain embodiments, a method for advertising using interactive mixed media involves providing a list of the items being advertised, as well as a content selection tool including multiple selection fields. Each item in the list of the advertised items corresponds to multiple advertising content components. Furthermore, each of the multiple selection fields corresponds to one of the multiple advertising content components. The method may involve receiving a request corresponding to an advertised item from the list of the advertised items, and providing two or more of the initial advertising content components that correspond to the advertised item indicated in the request. The method may proceed with receiving the selection of a field in the content selection tool, and then providing replacement advertising content to replace one of the two or more of the initial advertising content components, thus forming a set of the provided advertising content components. The replacement advertising content corresponds to the selected field.

In certain embodiments, the method may also involve receiving a selection of a new field in the content selection tool, as well as providing new replacement advertising content to replace one advertising content component in the set of the provided advertisement content components while leaving the rest of the provided content intact. The replacement advertising content corresponds to the newly selected field. The remaining advertising content may include, for example, an audio. In this example, the replaced advertising content may include a video that corresponds to the audio in the remaining advertising content. The replacement advertising content may include an image that corresponds to the audio in the remaining advertising content.

In certain embodiments, the replaced advertising content includes an initial audio, while the replacement advertising content includes another audio. For example, this may happen when, the initial audio and the replacement audio include narrations in two different languages. In certain embodiments, the replaced advertising content includes an initial text, while the replacement advertising content includes a new text. For example, this may happen when the initial text and the replacement text are in two different languages, for example.

In certain embodiments, the replaced advertising content includes an initial video, while the replacement advertising content includes a new video. For example, the initial video may correspond to the new video in terms of the content and information provided in it, but the two videos may have different resolutions. A user with a slower internet connection may choose a video with a lower resolution, while a user with a faster internet connection may choose a video with a higher resolution.

In certain embodiments, the multiple advertising content components have one or more of the following formats: text, photo, video, and audio. The two or more of the initial advertising content components may be provided for displaying in two or more different screen areas. The replacement advertising content may be used to replace one or more of the two or more of the initial advertising content components in one or more of the two or more different screen areas. At least one field of the multiple selection fields of the content selection tool may include an icon representing the corresponding advertising content. Two of more fields of the multiple selection fields of the content selection tool may represent two or more different types of content, selected from the group and consisting of: text, photo, video, and audio. In certain embodiments, the method may also involve providing a purchase tool for purchasing the advertised item.

Provided is also a computer-readable medium that includes instructions, which, when executed by one or more processors, perform the following operations. One operation may be to provide a list of the advertised items. Each item corresponds to multiple advertising content components. Another operation may involve providing a content selection tool that includes multiple selection fields. Each of the multiple selection fields may correspond to one of the multiple advertising content components. Additional operations may involve receiving a request that corresponds to an advertised item from the list of the advertised items, providing two or more of the initial advertising content components that correspond to the advertised items, and receiving the selection of a field in the content selection tool. One of the operations may involve providing a replacement advertising content component to replace one of the two or more initial advertising content components, thus forming a set of the provided advertisement content components. The replacement advertising content component may correspond to the selected field.

Provided is also a computer system that may be utilized for advertising purposes using interactive mixed media. The system may include a processing module for the provision of a list of the advertised items and content selection tool that includes multiple selection fields. The system may also be used to provide replacement advertising content to replace one of the two or more of the initial advertising content components, thus forming a set of the provided advertising content components. The system may also include an input module that may be used to receive a request that corresponds to an advertised item from the list of the advertised items, as well as for providing two or more of the initial advertising content components that corresponds to the advertised items and receive the selection of a field in the content selection tool.

These and other embodiments are described further below with reference to the figures.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram, illustrating an example of the overall system for implementing an advertisement and retail environment, in accordance with the various embodiments.

FIG. 2 is a block diagram, showing the various modules of the computer system that may be utilized for advertising purposes using interactive mixed media, in accordance with certain embodiments.

FIG. 3 is a flow chart illustrating a method for advertising using interactive mixed media, in accordance with certain embodiments.

FIG. 4 illustrates an example of a computer system, in which the various embodiments may be implemented.

FIG. 5 illustrates an example of a content selection tool.

### DETAILED DESCRIPTION OF EXAMPLE EMBODIMENTS

In the following description, numerous specific details are set forth in order to ensure a thorough understanding of the presented concepts. The presented concepts may be practiced without some or all of these specific details. In other instances, operations related to well-known processes have not been described in detail so as not to unnecessarily obscure the described concepts. While some concepts will be described in conjunction with the specific embodiments, it will be understood that these embodiments are not intended to be limiting.

Online retail and marketing are becoming more and more popular with the development of the Internet and computer technologies. With each passing year, more and more people buy products and serviced online However, online shopping is still encumbered with several shortcomings that include a lack of human interaction and the insufficient ability to understand the needs and wants of individual consumers. Shopping websites are designed using the one-size-fit-all approach, while different people typically seek different types of information on one and the same product. Some people may need more detailed information, while others may be more interested in the visual appeal of the product and would like to see more photos or videos.

Provided are methods and systems for advertising using interactive mixed media, which are based on the provision of multiple advertising content components in the same user interface, whereby users are allowed to switch between the different advertising content components using a content selection tool provided by the interface. Specifically, the different content formats may be simultaneously combined in the same user interface and then modified by the user to constitute the most optimal collection of the advertising content components. The user may toggle between the different advertising content components to gather some additional information. For example, the initially presented content may provide some general product information. The user may then choose to explore some specific features of the product by selecting some specific part of the content. Furthermore, the user may select content that is more suitable for him or her user, such as, for example, content in a specific language, or content that meets some specific interests of the user.

In certain embodiments, a method of advertising using interactive mixed media involves providing a list of the advertised items and a content selection tool that includes multiple selection fields. Each item on the list of the advertised items corresponds to multiple advertising content components. Furthermore, each of the multiple selection fields corresponds to one of the multiple advertising content components. The method may involve receiving a request that corresponds to an advertised item from the list of the advertised items, as well as providing two or more of the initial advertising content components corresponding to the advertised item indicated in the request. The method may proceed with receiving a selection of a field in the content selection tool, and then providing a replacement advertising content to replace one of the two or more of the initial advertising content components, thus forming a set of the provided advertising content components. The replacement advertising content corresponds to the selected field.

While the description in this document is focused on advertisements placed on retailers' website and the displaying of such advertisements on the potential shopper's computer system, it will be understood that the proposed techniques are scalable and they can be used in other advertising environments, such as an outdoor advertising board, an outdoor TV, an outdoor viewing screen, and so forth.

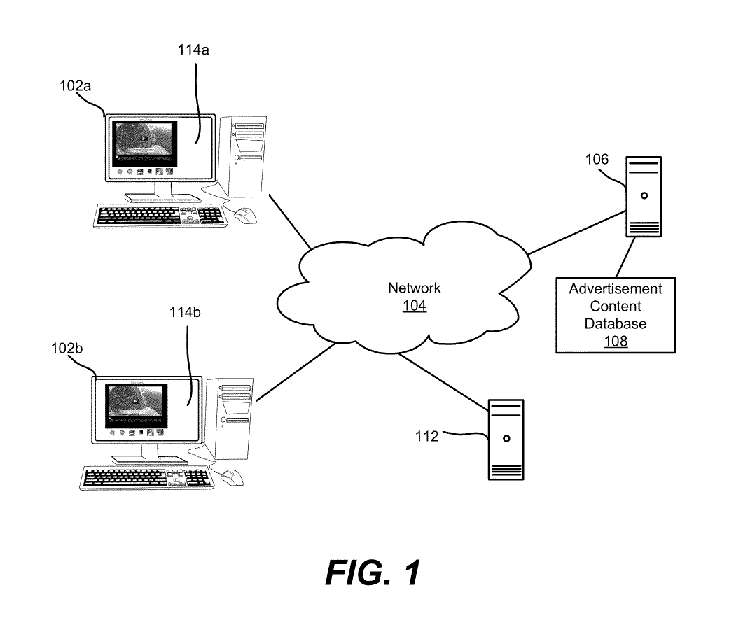

The description of the various methods and associated operations should be preceded by a brief description of the computer network. Specifically FIG. 1 illustrates an example network segment for implementing the various aspects of the methods and operations for advertising using interactive mixed media. As is shown, multiple user systems 102a and 102b may be configured to display shopping interfaces 114a and 114b. An example of such a shopping interface is presented in FIG. 6 and further described below. User systems 102a and 102b communicate with the online retailer server 106 via the network 104. The online retailer server 106 is part of the shopping system, which may include an advertising content database 108. A third-party advertisement server 112 may be also connected to the network for interacting with the online retailer server 106, or it may even be connected directly to the user systems 102a and 102b. For example, an online retailer may be selling products from one more brand owners that provide marketing content. This content may be fed to the retailer system's advertising content database 108, and then used on the website. In certain embodiments, the website may provide fields and links, while the content is supplied directly by a third-party advertisement server 112.

Network 104, which is used for communicating with the user systems 102a and 102b, the online retailer server 106, and the third-party advertisement server 112, may take any suitable form, such as, for example, that of a wide area network, or the Internet and/or one or more local area networks (LAN's). The network 104 may include any suitable number and type of devices, e.g., routers and switches, to be used for forwarding commands, content, and/or web object requests from each client to the online community application, as well as for sending responses back to the clients.

The methods described herein may also be practiced in a wide variety of network environments (represented by network 104) including, for example, TCP/IP-based networks, telecommunications networks, wireless networks, etc. In addition, the computer program instructions may be stored in any type of computer-readable media. The program may be executed based on a variety of computing models, including a client/server model, a peer-to-peer model, on a stand-alone computing device, or based on a distributed computing model, whereby the various functionalities described herein may be implemented or employed at different locations.

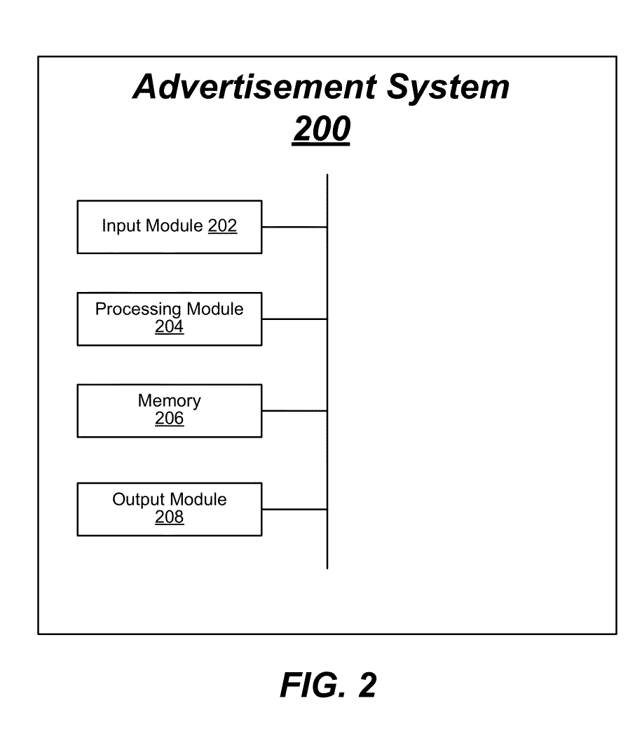

FIG. 2 is an example of an advertising system 200 that may be used for advertising using interactive mixed media. The advertising system 200 may be part of the online retailer system described above with reference to FIG. The advertising environment system 200 may be implemented, for example, on an online retailer's server (component 106 in FIG. 1), or on some other types of computer systems. The advertising system 200 may include an input module 202 for receiving a request that corresponds to an advertised item from the list of the advertised items. This module may be also used for providing two or more of the initial advertising content components that correspond to the advertised items, and/or for receiving the selection of a field in the content selection tool.

The advertising system 200 may include a processing module 204, used to provide a list of the advertised items. As described elsewhere in this document, each item on this list corresponds to multiple advertising content components. The processing module 204 may be also used for providing a content selection tool that comprises multiple selection fields. Each of the multiple selection fields may correspond to one of the multiple advertising content components. The processing module 204 may also be used for providing replacement advertising content to replace one of the two or more of the initial advertising content components, thus forming a set of the provided advertisement content components. The replacement advertising content corresponds to the selected field.

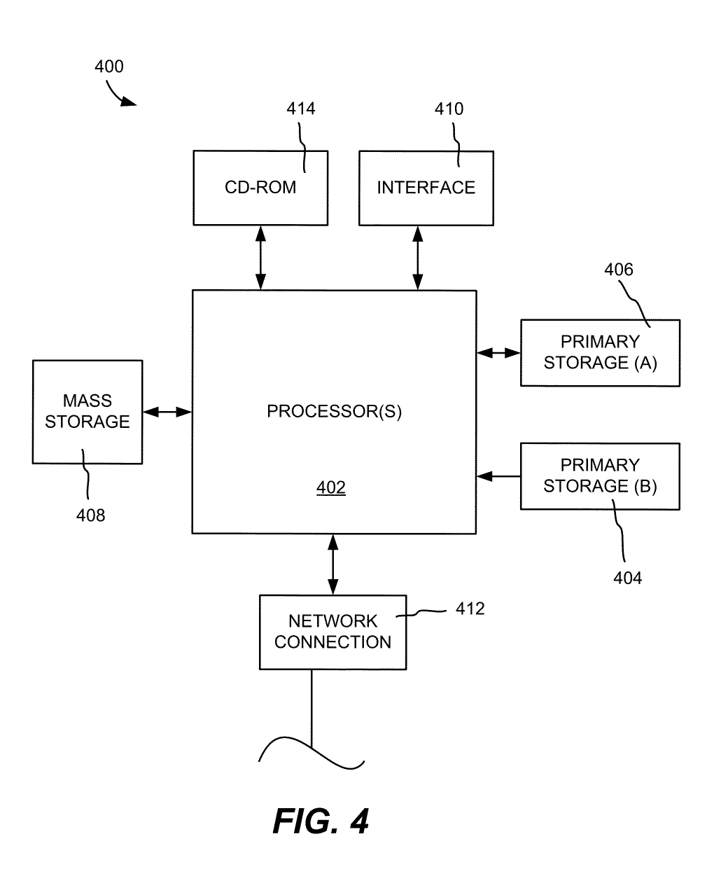

The advertising system 200 may include memory 206, such as tangible computer-readable memory. Various examples of such memory are described further below with reference to FIG. 4. Memory 206 may be used to store user preferences with respect to advertising content and other instructions, as well as some or all of the advertising content. The advertising system 200 may also include the output module 208 for displaying third-party advertisements, associated with the product or service.

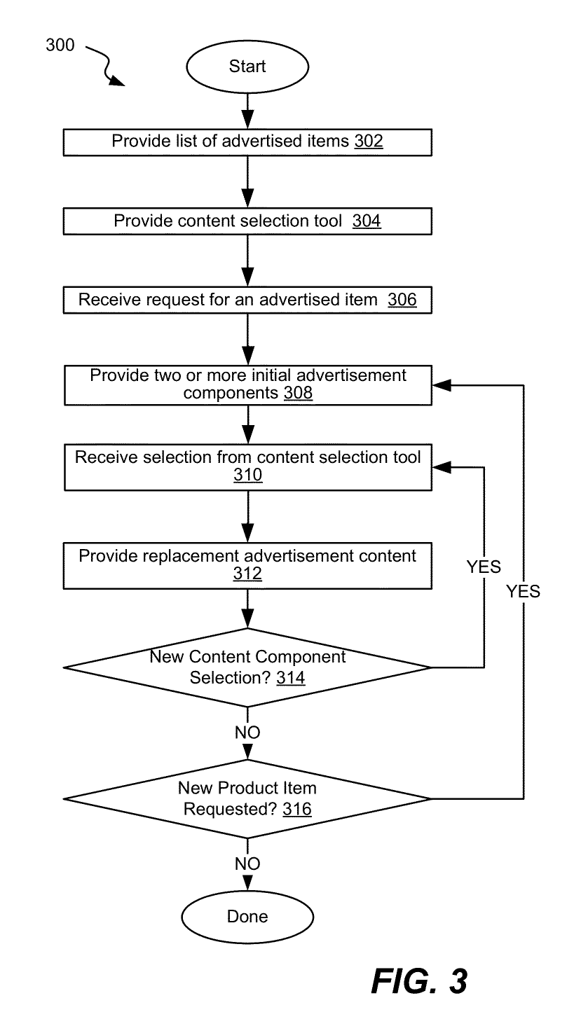

FIG. 3 is a process flowchart that describes the method 300 for advertising using interactive mixed media, in accordance with certain embodiments. The method 300 may start with providing a list of the advertised items during operation 302. The advertised items may include the actual product items available for shipping or pickup after ordering through a website and/or services which may be delivered over the Internet, or provided in accordance with some other arrangements. The advertised items may be catalogued and/or categorized. For example, a top level list may include product categories, such as digital cameras. Once one of these product categories is selected by the user, the method may proceed with providing sub categories and/or individual product items or services. For the purposes of this document, the advertised items also include product and service categories.

Each advertised item may have multiple advertising content components corresponding to it. As is noted above, this applies to all types of advertised items, e.g., product items, service items, categories, etc. Advertising content may be provided in various forms and formats, such as audio, video, photo and text. Each type of advertising content may include multiple content components. For example, different audio or video clips or text snippets may describe different features of a product or service, e.g., the resolution of the selected digital camera, related warranty information and user feedback. In the same or other embodiments, the same type of information content may relate the same information but in other languages. The user may select the content in their language of choice. In certain embodiments, the selection of one advertising content component in one language triggers the automatic selection of the other components in the same language. For example, a user may initially be presented a video clip with a corresponding audio in English. The user may choose to change the audio portion to Chinese. The original video clip may still remain but the audio part will be in Chinese. In other embodiments, the video may be changed too, for example, a product that was shown with English labels/packaging may now be shown as with Chinese labels/packaging. The system may remember the user's language preferences and continue providing advertising content in the appropriate language. For example, if after a while the user chooses to access some text-type information, it may be shown in Chinese, and not in English.

Furthermore, advertising content components of the same type and containing the same information may still be different in their various other properties, such as, for example, resolution/quality of video, photo, and sound, text size and font, color schemes, and other characteristics. For example, a user may have a slow Internet connection in one instance (e.g., 3G cell phone connection) and choose to view all the types or just some types (e.g., video) of the content in low quality. The system may remember this preference and continue to provide advertising content components suitable for this connection speed. In another instance, the same or different user may have a faster Internet connection (e.g., the Wi-Fi portion of a high speed network) and he or she may choose to view the same information using other advertising content components that are of higher quality.

As stated above, each advertised item includes multiple advertising content components. In certain embodiments, one or more advertising content components, associated with one advertised item, may be also linked to another advertised item. For example, two product items may be in the same category, or they may be provided by the same manufacturer and share some general information.

Method 300 may proceed with providing a content selection tool during operation 304. The content selection tool includes multiple selection fields. Each one of these fields corresponds to one of the multiple advertising content components. Each selection field can correspond to a different type of an advertising content component, such as a text-type advertising content component, a photo-type advertising content component, a quote-type advertising content component, a link-type advertising content component, a chat-type advertising content component, an audio-type advertising content component, and a video-type advertising content component. Some of these types of advertising content components will now be described in more detail.

The selection field can correspond to a text-type advertising content component retrieves this content component, displaying it on the computer screen. This field may correspond to one or more text-type advertising content components, which are chosen based on the selected advertised item and/or some user preferences. For example, the same content selection tool may be provided for the different selections of advertised items. In other words, when a user selects another item from the list of the advertised items, the content selection item is not updated. Yet, the advertisement content component that corresponds to one or more of these fields is changed. In a particular example, the same text-type selection field may correspond to the description of one product item, when this product item is chosen from the list of the advertised items, and, in a different time frame, it may correspond to the description of a different product item when this different product item is selected from the list.

Furthermore, multiple advertising content components may correspond to the same field for the same advertised products. These advertising content components may vary based on different characteristics, including language (e.g., English and Chinese), file size (e.g., high definition video v. low quality video), content length (e.g., short message, corresponding to a summary v. a long message, corresponding to the full description), content sophistication (e.g., a simple explanation v. a highly technical explanation), demographics-specific content (e.g., content that can be classified based on the differences existing on the age, gender, income, and education levels), and various other characteristics. These categories are provided for illustrative purposes only, and are not limited to these examples. Of course, a service provider may mix and match these categories to come up with more specifically targeted content that would meet multiple characteristics, e.g., younger Chinese-speaking and more technically savvy users v. older English-speaking and less technically savvy users.

Other fields, such as the chat-type field may correspond to the advertising content components that may comprise invoking an interactive chat screen. From a user perspective, this chat screen may be the same regardless of the selected specific advertised item. However, a chat partner may be made aware of the current product selection and, for example, of the user's previous interactions (e.g., clickstream), in order to provide more effective information to the user.

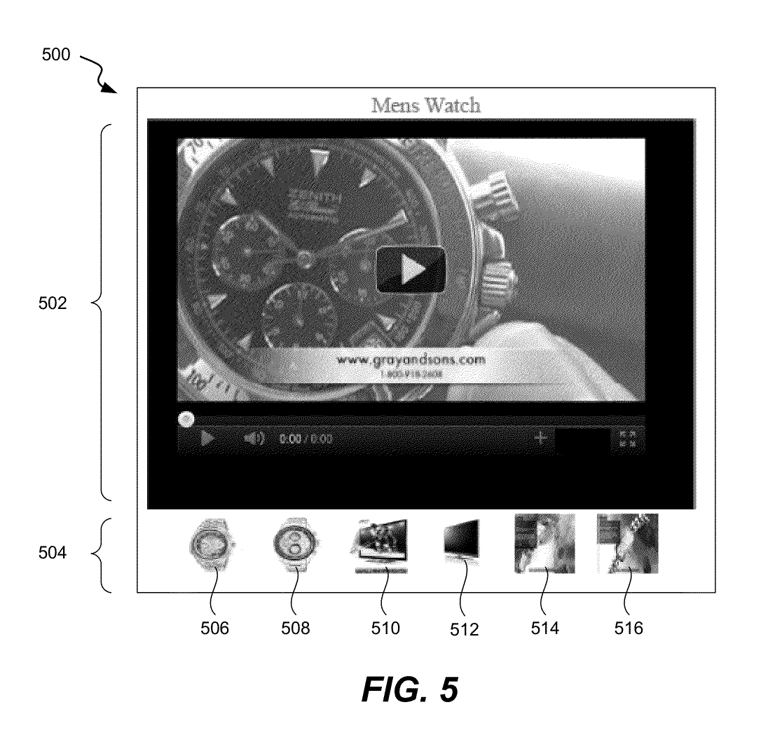

In certain embodiments, two or more selection fields may correspond to the same type of advertising content components. FIG. 5 illustrates an example of a user interface portion 500 which contains a display portion 502 for presenting any types of visual advertising content, as well as a content selection tool 504. When a product item is initially selected, the display portion 502 may automatically display the video content. In certain embodiments, the video content may need to be further activated by, for example, clicking the “play” button on the display portion 502. The corresponding audio content may proceed at this moment as well. The content selection tool 504 is shown to include six fields 506-516, all of which may correspond to photo-type advertising content components. For example, a video may describe the common features of watches, while the photos of these advertising content components may correspond to different watch models. When a user points with the cursor or some other pointing object to one of these six fields, the corresponding photo is displayed in the display portion 502. The audio may continue playing on the background. The user may not need to click any of these fields but just hover over them. If the user does not hover over any of the fields, the display portion 502 goes back to the video, for example, to the part of the video that corresponds to the current audio. In other embodiments, the display portion 502 may revert to the remaining part of the video. However, in these embodiments, the audio content may be discontinued together with the video (to ensure the correspondence between the video and audio), or some general audio content (e.g., some generic music may be used).

A content selection tool may be provided before a request that corresponds to an advertised item from the list of the advertised items is received during operation 306. In these embodiments, this initial content selection tool may correspond to some general product categories, website functionalities, and some other general information. For example, one of the multiple selection fields may correspond to the online retailer's text-format contact information. Another one of the fields may include a video tutorial that provides instructions related to the various functionalities of the website. Yet another filed may correspond to the commercial of a product or brand that the retailer is particularly interested in selling.

In other embodiments, a content selection tool is provided after a request for an advertised item from the list of the advertised items is received during operation 306. In these embodiments, the content selection tool may be specific to the selected advertised item as, for example, shown in FIG. 5. In other embodiments, the content selection tool may be provided prior to when an advertised item is requested. The content selection tool may then be updated when the request for a specific advertised item is received. As stated elsewhere in this document, the fields of the content selection tool may not only correspond to advertising content components specific to the selected advertised item, but they may also reflect some information contained in these advertising content components. For example, one or more fields that correspond to the photo-type advertising content components may include small photo-based icons corresponding to the content. In other words, the user may have some preview of the content while viewing the content selection tool.

Method 300 may proceed with receiving a request that corresponds to an advertised item from the list of the advertised items during operation 306. For example, the user may select a product or service category, or a specific product or service item. In response, method 300 may initiate operation 308, during which two or more of the initial advertising content components that correspond to the advertised item, indicated in the request, are provided. In the example described above with reference to FIG. 5, two initial advertising content components may include a video and a corresponding audio. In certain embodiments, the user may be presented with an option to select the initial advertising content components and/or to set preferences for the displaying of the initial and subsequently added advertising content components.

The method may then proceed with receiving the selection of a field in the content selection tool during operation 310. The user may simply point to one of the fields in the content selection tool, or point and click (or use some other equivalent activation techniques when a mouse is not used) to select the field. In certain embodiments, the user may select multiple fields simultaneously to update multiple advertising components at once.

In response to the selection of one or more fields in the content selection tool, method 300 may proceed with providing replacement advertising content to replace one or more of the initial advertising content components during operation 312. This replacement advertising content may be combined with the remaining initial content to form a set of the provided advertising content components. This set may be updated again during the later operation. Similar to the initial advertising content components, the set may include multiple advertising content components of the mixed media type, which may include various combinations of video, audio, photo, and text content. The different content formats are combined in the same user interface at the same time, the process being referred to as mixed media. Furthermore, this mixed media may be updated based on the user's usage of the content selection tool, resulting in the creation of interactive mixed media.

This form of media, i.e., interactive mixed media, is in part tailored by the user and comprises different types of media, which makes it a lot more informative and understandable. In general, interactive mixed media is considered to be much more user-friendly than any other known forms of advertising content. A user may tailor t interactive mixed media content based on the various factors that may be specific to this user and their instant circumstances. For example, one user may be more receptive to visual stimulation, while another user may be more receptive to audio, and yet another user may prefer to read about the product rather than see a video of the product or hear about it. Even the same user may have more time and be willing and interested to conduct a more detailed research one day, and then be in a hurry and need only some basic summaries some other day. Interactive mixed media allows the user to adapt content of this type for any of the above circumstances.

Method 300 also involves two decision blocks—314 and 316. As explained above, the set of the provided advertising content components that correspond to a specific advertised item may be updated one or more times, which is represented by the inner loop in FIG. 3 and decision block 314. For example, the user may toggle between the different fields of the content selection tool until he or she receives sufficient information about this product. At a certain point, the user may finally have enough information to add this item to the shopping cart (not shown in FIG. 3). Once the user has completed the performance of the actions/operations related to the first item, he or she may select another advertised item from the list. This selection activates the outer loop in FIG. 3 and decision block 316. In this case, operations 308-314 may be repeated for the newly selected advertised item. The process may continue for as many advertised items as the user wants to add. In certain embodiments, method 300 keeps a log of the items selected by the user. This log may be presented to the user when the user wants to revert to one or more of the previously viewed items. In the same or other embodiments, the log may be analyzed by the service provider's system to offer the user some suggestions and, in certain embodiments, discounts.

FIG. 4 illustrates a computer system that may be configured or designed for performing various operations described above, in accordance with certain embodiments. The computer system 400 includes any number of processors 402 (also referred to as “central processing units”, or “CPUs”) that are coupled to storage devices, including primary storage 406 (typically, a random access memory, or RAM), primary storage 404 (typically, a read-only memory, or ROM). CPU 402 may be of various types, including microcontrollers and microprocessors, such as programmable devices (e.g., CPLDs and FPGAs) and unprogrammable devices, such as gate array ASICs, or general-purpose microprocessors. Primary storage 404 may act to transfer data and instructions uni-directionally to the CPU and primary storage 406 is used typically to transfer data and instructions in a bi-directional manner. Both of these primary storage devices may include any suitable computer-readable media, such as those described above. A mass storage device 408 is also coupled bi-directionally to CPU 402 and provides additional data storage capacity. It may include any of the computer-readable media described above. The mass storage device 408 may be used to store programs, data, and the like, and is typically a secondary storage medium, such as a hard disk. It will be appreciated that the information retained in the mass storage device 408, may, in appropriate cases, be incorporated in a standard fashion as virtual memory and part of the primary storage 406. A specific mass storage device, such as a CD-ROM 414, may also transfer data uni-directionally to the CPU.

CPU 402 may also be coupled to an interface 410 that connects to one or more input/output devices, such as such as video monitors, track balls, mice, keyboards, microphones, touch-sensitive displays, transducer card readers, magnetic or paper tape readers, tablets, styluses, voice or handwriting recognizers, or any other well-known input devices such as, of course, other computers. Finally, CPU 402 may optionally be coupled to an external device, such as a database, or a computer, or a telecommunications network using an external connection, as shown generally at 412. With such a connection, it is contemplated that the CPU might receive information from the network, or that it might output information to the network during the performance of the operations described herein.

The example embodiments described herein may be implemented in an operating environment, including software installed on a computer, hardware, or a combination of software and hardware.

Although the foregoing concepts have been described in some detail for the purpose of facilitating understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A method of advertising using interactive mixed media, the method comprising:
providing a list of advertised items, each item corresponding to multiple advertisement content components;
providing a content selection tool comprising multiple selection fields, each field of the multiple selection fields corresponding to one advertisement content component of the multiple advertisement content components;
receiving a request corresponding to an advertised item from the list of the advertised items;
providing two or more initial advertisement content components corresponding to the advertised item indicated in the request;
receiving the selection of a field in the content selection tool; and
providing replacement advertisement content to replace one of the two or more initial advertisement content components to form a set of the provided advertisement content components, the replacement advertisement content corresponding to the selected field.

2. The method of claim 1, further comprising:
receiving a new selection of a new field in the content selection tool; and
providing new replacement advertisement content to replace one advertisement content in the set of the provided advertisement content components leaving a remaining advertisement content provided, the replacement advertisement content corresponding to the new selected field.

3. The method of claim 2, wherein the remaining advertisement content comprises an audio.

4. The method of claim 3, wherein the replaced advertisement content comprises a video corresponding to the audio of the remaining advertisement content.

5. The method of claim 4, wherein the replacement advertisement content comprises an image corresponding to the audio of the remaining advertisement content.

6. The method of claim 2, wherein the replaced advertisement content comprises an initial audio and wherein the replacement advertisement content comprises a new audio.

7. The method of claim 6, wherein the initial audio and the replacement audio comprise narrations in two different languages.

8. The method of claim 2, wherein the replaced advertisement content comprises an initial text, and wherein the replacement advertisement content comprises a new text.

9. The method of claim 8, wherein the initial text and the replacement text are in two different languages.

11. The method of claim 2, wherein the replaced advertisement content comprises an initial video, and wherein the replacement advertisement content comprises a new video.

12. The method of claim 11, wherein the initial video corresponds to the new video and wherein the initial video has a different resolution than the new video.

13. The method of claim 1, wherein the multiple advertisement content components have one or more formats selected from the group consisting of: text, photo, video, and audio.

14. The method of claim 1, wherein the two or more initial advertisement content is provided for displaying in two or more different screen areas.

15. The method of claim 1, wherein the replacement advertisement content replaces one or more of the two or more initial advertisement content in one or more of the two or more different screen areas.

16. The method of claim 1, at least one field of the multiple selection fields of the content selection tool comprises an icon representing the corresponding advertisement content.

17. The method of claim 1, two of more fields of the multiple selection fields of the content selection tool represent two or more different types of content selected from the group consisting of: text, photo, video, and audio.

18. The method of claim 1, further comprising providing a purchase tool for purchasing the advertised item.

19. A computer-readable medium comprising instructions, which when executed by one or more processors, perform the following operations:
provide a list of advertised items, each item corresponding to multiple advertisement content components;
provide a content selection tool comprising multiple selection fields, each field of the multiple selection fields corresponding to one advertisement content component of the multiple advertisement content components;
receive a request corresponding to an advertised item from the list of advertised items;
provide two or more initial advertisement content components corresponding to the advertised items;
receive a selection of a field in the content selection tool; and
provide a replacement advertisement content to replace one of the two or more initial advertisement content components to form a set of provided advertisement content components, the replacement advertisement content corresponding to the selected field.

20. A computer system for advertising using interactive mixed media, the system comprising:
a processing module for:
providing a list of advertised items, each item corresponding to multiple advertisement content components;
providing a content selection tool comprising multiple selection fields, each field of the multiple selection fields corresponding to one advertisement content component of the multiple advertisement content components; and
providing a replacement advertisement content to replace one of the two or more initial advertisement content components to form a set of provided advertisement content components, the replacement advertisement content corresponding to the selected field; and
an input module for:
receiving a request corresponding to an advertised item from the list of advertised items;
providing two or more initial advertisement content components corresponding to the advertised items; and
receiving a selection of a field in the content selection tool.
